(19) United States
(12) Patent Application Publication
(10) Pub. No.: US 2008/0162934 A1
(43) Pub. Date: Jul. 3, 2008

(54) Secure transmission system

(75) Inventor: Katsuyoshi Okawa, Tokyo (JP)

Correspondence Address: Martin D. Moynihan;PRTSI, Inc., P.O. Box 16446, Arlington, VA, 22215, US

(73) Assignees: Katsuyoshi Okawa, Tokyo (JP); Modus ID Corp., Tortola (VG)

(21) Appl. No.: 12/071,993

(22) Filed: Feb. 28, 2008

Related U.S. Application Data
(63) Continuation-in-part of application No. PCT/JP2007/000495, filed on May 9, 2007.

(30) Foreign Application Priority Data
Sep. 20, 2006 (JP) 2006-255010

(51) Int. Cl. H04L 9/00

(52) U.S. Cl. 713/169

(57) ABSTRACT

A method of mutual authentication between a server and a plurality of clients, including:

(a) generating, by a client, a first client random number and a first client one time ID based on first and second values;

(b) sending the first client one time ID and an encrypted version of the first client random number to the server by the client;

(c) generating, by the server, a first server random number and a first server ID based on the first client random number and the first value;

(d) sending, by the server, the first server one time ID and an encrypted version of the first server random number to the client by the server;

(e) generating, by the client, a second client random number and a second client one time ID based on said first server and first client random numbers;

(f) sending, by the client, the second client one time ID and an encrypted version of the second client random number to the server by the client;

(g) generating, by the server, a second server random number and a second server one time ID based on the second client random number and first server random number; and

(h) repeating (d) to (g), using updated random numbers and client and server one time IDs to provide periodic authentication, wherein the one time IDs thus generated do not contain any unchanging arguments intrinsically related to the two parties.

### RELATED APPLICATION/S

This application is a continuation-in-part of PCT patent application Ser. No. PCT/JP2007/000495 filed on May 9, 2007, which claims priority from Japanese Patent Application No. 2006-255010 filed on Sep. 20, 2006.

The contents of all of the above documents are incorporated by reference as if fully set forth herein.

### FIELD AND BACKGROUND OF THE INVENTION

The present invention, in some embodiments thereof, relates to a communication system between a server and one or more clients and, more particularly, but not exclusively, to a system utilizing one time IDs.

WO 2004/01953 (also published in English as US 2006/0143453 A1) describes a system in which one time IDs are generated by server and clients and used to periodically identify server and clients to each other.

A paper entitled Analysis of the security of ID Information in Internet Key Exchange, presented at SCIS 2002, The 2002 Symposium on Cryptography and information Security Jan. 29-Feb. 1, 2002, describes a system for identifying clients and server to each other, once.

Japanese patent publication Hei 10-20783 describes a system for generating one time IDs.

The contents of the above documents are incorporated herein by reference as if fully set forth herein.

### SUMMARY OF THE INVENTION

According to an aspect of some embodiments of the present invention there is provided a communication system between a server and one or more clients and, more particularly, but not exclusively, to a system utilizing one time IDs.

There is thus provided in accordance with an embodiment of the invention a method of mutual authentication between a server and a plurality of clients, comprising:

(a) generating, by a client, a first client random number and a first client one time ID based on first and second values;

(b) sending the first client one time ID and an encrypted version of the first client random number to the server by the client;

(c) generating, by the server, a first server random number and a first server ID based on the first client random number and the first value;

(d) sending, by the server, the first server one time ID and an encrypted version of the first server random number to the client by the server;

(e) generating, by the client, a second client random number and a second client one time ID based on said first server and first client random numbers;

(f) sending, by the client, the second client one time ID and an encrypted version of the second client random number to the server by the client;

(g) generating, by the server, a second server random number and a second server one time ID based on the second client random number and first server random number; and

(h) repeating (d) to (g), using updated random numbers and client and server one time IDs to provide periodic authentication, wherein the one time IDs thus generated do not contain any unchanging arguments intrinsically related to the two parties.

2. A method according to claim 1 wherein first and second numbers are numbers that are pre-stored in the client and server and are used, prior to (a), to initiate a first authentication cycle in place of the client and server random numbers.

In an embodiment of the invention, the first and second numbers are random numbers that are generated in accordance with a previous authentication cycle.

Optionally, the method is initiated by a trigger from outside the client and outside the server. Alternatively, the method is initiated by a trigger from the server. Alternatively, the method is initiated by the client.

In an embodiment of the invention, the one time ID is an output of a one way function, optionally a hash function.

In an embodiment of the invention, the encryption utilizes a cipher-key that changes periodically. Optionally, the encryption utilizes an encryption key that changes with each authentication cycle.

In an embodiment of the invention, the encryption key is responsive to first and second random numbers generated in a previous authentication cycle.

In an embodiment of the invention, the method includes identifying the client from the client ID and authenticating, by the server, that the client is authentic.

In an embodiment of the invention, identifying and authenticating the client comprises:

determining by the server if the ID received from the client is an updated ID expected from one of the clients;

if it is not, checking if a next previous ID is an ID expected from one of the clients;

identifying and authenticating the client as a particular client if the received ID matches an expected ID from that client.

In an embodiment of the invention, the method includes authenticating the server by the client. Optionally, authenticating the server by the client comprises:

determining by the client if the ID received from the server is an updated ID expected from the server;

authenticating the client if the received ID matches an expected ID from the server.

Optionally, if the ID received from the server does not match an expected ID:

the method includes:

sending an authentication message from a client to a server, the message comprising the last valid one time ID sent by the client to the server;

determining by the server if the ID is an updated ID expected from one of the clients;

if it is not, checking if a next previous ID is an ID expected from one of the clients;

if it is, identifying the message as being from the client associated with the next previous ID and authenticating the client transmission; and

generating and sending according to a message to the server according to (c) and (d).

In an embodiment of the invention, the method includes sending data when the recipient of the data has been authenticated. Optionally, the data is sent in encrypted form. Optionally, the encryption used to send the data utilizes a same encryption key as used to encrypt the last random number sent by the sender. Optionally, the encryption used to send the data is sent using the same encryption function used to encrypt the last random number sent by the sender.

In an embodiment of the invention, generating said server random numbers comprises:

(i) generating a candidate random number by the server;

(j ) computing a candidate client one time ID based on the candidate random number;

(k) checking if the candidate client one-time ID is active for another client; and
(1′) if it is not, sending the candidate random number to the client;
(1″) if it is, repeating (i) to (k) until a candidate ID not in use is found.

In an embodiment of the invention, the on-time IDs are, after an initialization period, based only on random numbers generated by the client and the server.

There is further provided, in accordance with an embodiment of the invention a method of generating one-time IDs in a system having a plurality of clients communicating with a server, in which the IDs for the clients are generated from random numbers supplied to the clients, comprising:

(a) generating a candidate random number by the server;

(b) computing a candidate client one time ID based on the candidate random number;

(c) checking if the candidate client one-time ID is active for another client; and
(d′) if it is not, sending the candidate random number to the client;
(d″) if it is, repeating (a) to (c) until a candidate ID not in use is found.

There is further provided, in accordance with an method of recovery from a communication failure in a transmission system having a server and at least one client, in which the server and the client update their one-time IDs based on information received from each other, comprising:

sending an authentication message from a client to a server, the message comprising a one-time ID; and

determining by the server if the ID is an updated ID expected from one of the clients;
if it is not, checking if a next previous ID is an ID expected from one of the clients;
if it is, identifying the message as being from the client associated with the next previous ID and authenticating the client transmission.

Optionally, the communication failure is a failure of the server receiving a message from the client. Alternatively or additionally, the communication failure is a failure of the client receiving a message from the server. Optionally, the communication failure is a receipt by the client of a spurious message which appears to be from the server.

In an embodiment of the invention, wherein there is a loss of data that makes it impossible to identify the client from a one time ID generated by the client, the method comprising:

sending an authentication message by the client to the server, the message comprising a client one-time ID;

sending a response message by the server to the client comprising a server response based on the client one time ID and at least one confidential number common to all the clients;

determining, by the client, from the response message that the server is attempting to recover from a data loss; and

sending, by the client to the server, a recovery client ID, based at least on a confidential number specific to the server, such that on receipt, the server can identify the client.

Optionally, the authentication message is based on the last valid client and server random numbers known to the client.

Optionally, the authentication message and an accompanying client random number is the same as would have been sent by the client as in the absence of the failure in data, according to (a) and (b). Optionally, the server can not identify the client from the authentication message. Optionally, the response message sent by the server further comprises a random number. Optionally, the random number is sent unencrypted.

In an embodiment of the invention, the at least one common confidential number is encrypted using an encryption key responsive to the client ID received by the server, a common secret number and the random number received from the server. Alternatively, the at least one common confidential number is encrypted using an encryption key responsive to the client ID received by the server a secret number common to all the clients.

In an embodiment of the invention, the client determines from the form of the response message that the server is attempting to recover. Optionally, the recover client ID is also based on a second, server, number that is common to all the clients.

There is further provided, in accordance with an embodiment of the invention, a method of recovery from a loss of data in a server in a system in which one-time IDs are generated based on random numbers generated by both the server and the client, such that the loss of data makes it impossible to identify the client from a one time ID generated by the client, the method comprising:

sending an authentication message by the client to the server, the message comprising a client one-time ID;

sending a response message by the server to the client comprising a server response based on the client one time ID and at least one confidential number common to all the clients;

determining, by the client, from the response message that the server is attempting to recover from a data loss; and

sending, by the client to the server, a recovery client ID, based at least on a confidential number specific to the server, such that on receipt, the server can identify the client.

There is further provided, in accordance with an embodiment of the invention, a method of mutual authentication between a server and a plurality of clients, comprising:

(a) generating, by a client, a first client random number and a first client one time ID based on first and second values;

(b) sending the first client one time ID and an encrypted version of the first client random number to the server by the client;

(c) generating, by the server, a first server random number and a first server ID based on the first client random number and the first value;

(d) sending, by the server, the first server one time ID and an encrypted version of the first server random number to the client by the server;

(e) generating, by the client, a second client random number and a second client one time ID based on said first server and first client random numbers;

(f) sending, by the client, the second client one time ID and an encrypted version of the second client random number to the server by the client;

(g) generating, by the server, a second server random number and a second server one time ID based on the second client random number and first server random number; and

(h) repeating (d) to (g), using updated random numbers and client and server one time IDs to provide periodic authentication, wherein the on-time IDs are based on a function having, after an initialization period, as arguments only random numbers generated by the client and the server.

There is further provided, in accordance with an embodiment of the invention, a method of mutual authentication between a server and a plurality of clients, comprising:

(a) generating, by a client, a first client random number and a first client one time ID based on first and second values;

(b) sending the first client one time ID and an encrypted version of the first client random number to the server by the client;

(c) generating, by the server, a first server random number and a first server ID based on the first client random number and the first value;

(d) sending, by the server, the first server one time ID and an encrypted version of the first server random number to the client by the server;

(e) optionally generating, by the client, a second client random number and a second client one time ID based on said first server and first client random numbers;

(f) sending, by the client, the second client one time ID and an encrypted version of the second client random number to the server by the client;

(g) optionally generating, by the server, a second server random number and a second server one time ID based on the second client random number and first server random number; and

(h) repeating (d) to (g), using updated random numbers and client and server one time IDs to provide periodic authentication, wherein the one time IDs thus generated do not contain any unchanging arguments intrinsically related to the two parties,

wherein at least one number generated according to (e) or (g) is used on each authentication cycle and wherein where no new random number is used the subsequent sending utilizes the next previous generated random number.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 illustrates a methodology 100 for generating and using one-time IDs for authenticating server and/or client according to some embodiments of the invention;

FIG. 2 is a flow chart for carrying out the generation of the server random numbers and verifying the uniqueness of client IDs using it, according to some embodiments of the invention;

FIG. 3 is a simplified block diagram of an exemplary apparatus for carrying out the method described with respect to some embodiments of the invention;

FIG. 4 shows an exemplary simplified client table for use in some embodiments of the invention;

FIG. 5 is an alternative flow chart to that of FIG. 1;

FIG. 6 illustrates a methodology for recovery from a break in communication/authentication caused by a failure of a client to receive an authentication message from the server, in accordance with an embodiment of the invention;

FIG. 7 illustrates a methodology for recovery from a break in communication/authentication caused by a failure of the server to receive an authentication message from a client, in accordance with an embodiment of the invention; and

FIG. 8 illustrates a methodology for reset recovery from a loss of data in the server, in accordance with an embodiment of the invention.

### DESCRIPTION OF SPECIFIC EMBODIMENTS OF THE INVENTION

The present invention, in some embodiments thereof, relates to a communication system between a server and one or more clients.

An aspect of some embodiments of the invention relates to communication between a server and one or preferably a plurality of clients which provides continuing authentication of the clients and server, utilizing one time IDs, where the one time IDs are derived from functions using only arguments that are dynamically changing, preferably with each authentication cycle.

As used herein, the term “one time ID” is an ID:

a) that uniquely identifies a client to a server or identifies the server to the client;

b) that is generally different each time an identification is made; and

In general, the identification of the client should be unequivocal, that is no two clients have the same ID at the same time. It is understood that while it is desirable that there be no duplication of one-time server IDs for different clients, for added security, there is no fixed requirement that this be the case. However, it is desirable that both the client and server IDs change with each authentication.

In some embodiments of the invention a first party (server or client) receives a one time ID and a preferably encrypted random number from the second party. The first party generates its own one time ID from the random number of the second party and a first party random number which was previously sent to the second party. The first party also sends a preferably encrypted version of a new first party random number. The second party checks whether the first party ID it receives is properly generated from random number it sent to the first party and a previously received first party random number. If it does, the first party is authenticated.

Mutual authentication is performed by reversing the roles of the first and second parties and performing the same procedure.

It is noted that the IDs thus generated do not contain any information intrinsically related to the two parties, but are based only on the random numbers generated by each. Furthermore, not only are the one time IDs different for every authentication interaction, they are completely unpredictable without having knowledge of the series of random numbers interchanged and/or an ability to decrypt a series of previous messages.

As indicated above, the random numbers are preferably transferred in encrypted form. In an embodiment of the invention, the encryption key is changed for each pair of transmissions. In an embodiment of the invention, the encryption key depends on the previous encryption key and previous values of server and client random numbers. Utilizing unpredictable, ever changing encryption keys adds to the security of the authentication process.

An aspect of some embodiments of the invention relates to generation of one-time IDs in a communication system between a server and a plurality of clients, and to the avoidance of generation of conflicting (duplicate) IDs.

For efficiency, it is desirable that the one-time IDs utilized be relatively short both to reduce transmission bandwidth required and to simplify the process of generating the IDs. In an embodiment of the invention a hash function of the server and client random numbers is used as the ID. A relatively short ID is desirable, which may lead to the possibility of more than one client having (at some particular time) the same one-time ID. The shorter the ID and the larger the number of clients, the greater the possibility of having such duplication.

In an embodiment of the invention, the server keeps track of all the one time IDs that will be generated by the clients based on the server random numbers that the server is sending to them. If, when generating a random number for sending to a particular client, the server discovers that the random number would result in a duplication of client IDs, the server rejects the random number and generates a replacement random number.

In general it is useful to design the hash function such that such “provisional” conflicts will occur fairly often, in order to minimize the computation time for the IDs.

Since only a single server exists and since the server directs each message to a particular client, duplicate server one-time IDs do not pose a similar problem.

An aspect of some embodiments of the invention relates to methods of reconnection after a lost communication between a server and a plurality of clients in a communication system utilizing one time IDs which are not predetermined and which can not be predicted.

An aspect of some embodiments of the invention relates to resetting a communication system between a server and a plurality of clients after loss of variable client information by the server. This information is used to generate one time IDs by both the server and the client and in authenticating the server to the client and vice versa.

If any identification of sender is not stored other than in the In one possible scenario, an authentication message from a client does not reach the server. In this case the server does not know the new client random number and ID to be used in subsequent transmissions. Of course, when the server has not received the authentication message from the client, the server has not generated any new random number and has not sent any messages.

In a second scenario, the authentication message from the client reaches the server, but the reply message from the server does not reach the client. In this case the server has updated its random number and expects a new ID from the client when the client sends the next authentication message.

In both scenarios the client just knows that it has not received a response and knows that there is something has gone wrong. In an embodiment of the invention the client sends a new authentication message utilizing the same one-time ID as previously. However, a different client random number is generated and encrypted. Using a different random number makes it more difficult for a listener to determine how to impersonate the client.

If the first scenario is in place, then the server just receives the client ID and random number, checks the client ID against its listing and authenticates the client (and transmission). Since the server does not know of the previous transmission it is basically unaware that there was, in fact, any transmission difficulty. Continuing authentication continues in the manner described above.

If the second scenario is in place then the server has updated its list of server and client random numbers (and expected next client one time IDs). When the client sends an authentication message using its old ID, the server fails to find it on the list of expected IDs. However, before rejecting the communication, the server checks the ID received against a listing of next previous client IDs. If the ID is found on that list, then the server determines that there was a transmission error and cancels the change previously made and utilizes the presently received ID. Similar to this scenario is where the client receives a server ID which it does not recognize. In this case as well the client can reestablish communication in the same way as in the second scenario.

A third scenario is one in which the server crashes or otherwise loses the current random number. Since in the normal course of events the various transmissions do not directly identify the client, not only is the chain of authentication broken, but the server has no way of identifying the client when it receives an authentication message. In the prior art, where loss of information in the server occurred, the server had no way to restore communication than to broadcast a message to all clients that it has lost information and needs to be reset. This is provides a security weakness that can be exploited by hackers or the like.

An aspect of some embodiments of the invention is concerned with recovery from a loss of client data in a server and the identification of a client requesting authentication utilizing a one time ID, where the one-time ID does not specifically identify the client, unless the client data is known.

For this type of emergency situation the server and all of the clients have emergency reset information stored in a memory which is non-volatile. This information includes two common numbers and two numbers that are different for each client. The clients have only the information specific to them while the server has information has information pertaining to all of the clients.

In an embodiment of the invention, after recovery from a loss of data, when receiving an authentication request from a client the server (which can not identify the client) sends a message that includes a function of the received client ID and optionally a random number. The client is thus notified that the server is in need of a reset. The client then computes a new client ID that is a function (for example a hash function) of one of the common secret numbers and a first one of the specific secret numbers for that client. This is sent to the server, together with a preferably encrypted version of a recovery client random number. Since the server has all of the specific secret numbers and can compute or has pre-computed all the legal client reset IDs, the server is able identify the client. Preferably, the random number is encrypted utilizing a number that is a function, inter alia, of the second secret number. With knowledge of the client, the server is able to decrypt the random number.

The server now generates a server recovery random number. The server generates an ID from the first common secret number and the client recovery secret number and sends it to the client together with an encrypted version of the server recovery random number. The key for encryption is preferably the same as that used for the client transmission of its recovery random number.

At this point, both the client and the server have knowledge of a client random number, a server random number and an encryption key. With these in place, periodic authentication can proceed in the manner described above.

In some embodiments of the invention, the encryption key in the first transmission from the server is also a function of a second common secret number to make it harder to hack into the system.

Before explaining various embodiments of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

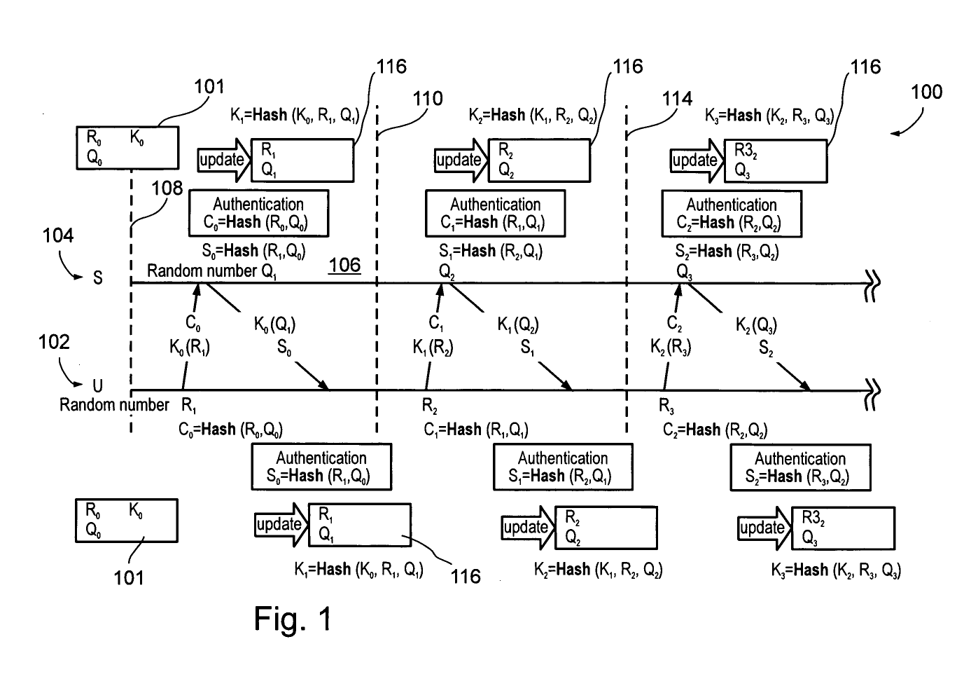

Referring now to the drawings, FIG. 1 illustrates a methodology 100 for generating and using one-time IDs for authenticating server and/or client, in accordance with some embodiments of the invention. In FIG. 1 the lower portion represents a client 102 (sometimes referred to as User “U”) and the upper portion represents a server 104 (“S”).

In the following description, the letter “R” corresponds to a random number generated at the client; the letter “Q” corresponds to a random number generated at the server; and the letter “K” corresponds to a varying encryption key used by both client and server. The letter “C” corresponds to a one time ID of the client and the letter “S” corresponds to a one time ID of the server, to identify the server to a particular client.

At an initial state, initial values for R, Q and K, designated Ro, Qo and Ko, are stored (101) in both the server and the client. Where there are multiple clients, one or more (or all) of the initial values may differ from user to user. Preferably, all the values are different for each user.

Initially, the client generates a random number R1 and a value

Co=Hash(Ro, Qo).

When at least one of the values of Ro and Qo are different for each user, the value Co acts as an ID and Co and random number R1 are transmitted to the server. Preferably, R1 is encrypted using key Ko. The R1 is used as a challenge from the client to the server. R1 replaces Ro in a store of the client.

It is to be understood that the server receives communications from a plurality of clients, while each client receives communications only from the server. Thus, the server must differentiate the client from other clients while the client need only authenticate that the server is genuine.

The server, which also generates Co (or has it already generated and stored) compares the Co received from the client and determines that it identifies the particular client who has sent it. If it does not correspond to a valid Co for one of the clients, it is ignored. If it does, then Ko(R1) is decrypted and R1 replaces Ro in the store of the server.

If the server identifies the client, it generates a new random number Q1 which replaces Qo in its memory and generates a new server ID:

So=Hash (R1, Qo).

For simplicity, the Hash functions used by both parties are the same. However, there is no fixed requirement that the same hash function be used by both client and server or even by every client although this is usually the case. If the Hash functions used by both parties are different, both parties must know the hash function used by the other party to generate the other party's ID, so that authentication can be performed

A useful hash function is concatenation of the arguments of the function. This function can be used no matter what the number of arguments. It should be understand that a hash (one way function) is desirable for security, a reversible encryption function could be used, particularly if a different encryption seed is used for each transmission.

The server replaces So in its store by the generated S1. The server then sends its server ID (response to the client challenge), So, to the client together with its optionally encrypted server random number Q1. Preferably, Ko is used as the encryption key.

Since the client knows R1 and Qo it can also generate S1 and can authenticate the server. If the server is authenticated, it decrypts Q1 and replaces Qo by Q1.

Both the server and client generate a new K value K1 as Hash (Ko, R1, Q1)

This ends a first authentication exchange (cycle), 106, as delineated by dotted lines 108 and 110.

Optionally, the R and Q numbers are 160 bits long and the C and S values are 256 bits long. While any Hash or other one-way function can be used, the MD5 Hash function is optionally used. The hash function generates a smaller, “digest” of the variables, which may not be unique to those variables.

In a second authentication exchange 112, delineated by dotted lines 110, 114, the process of exchange 106 is repeated with starting values R1, Q1 and K1 (116). The exchanges of IDs and challenges and the generation of new values is repeated using the new starting values. This continues with third and subsequent authentication exchanges.

As indicated above, the server should preferably be able to differentiate between different clients by their IDs. In an embodiment of the invention the server checks its store of current (and, optionally, last few) IDs in order to see if the ID that the client will generate from the currently generated Q and R are already assigned to any other client. If it is, then the server generates a new random number Q′ which it uses instead of the previously generated Q. It is noted that the client need not make this check (and in fact can not) since it need not differentiate among different servers, but only needs to authenticate that the server is not bogus. Furthermore, by rejecting random numbers Q that would duplicate IDs, the method allows for using smaller amounts of computation to produce shorter IDs. While using shorter IDs results in a greater incidence of collisions, checking and rejecting such collisions will allow for faster computation and transmission of IDs and faster identification of clients.

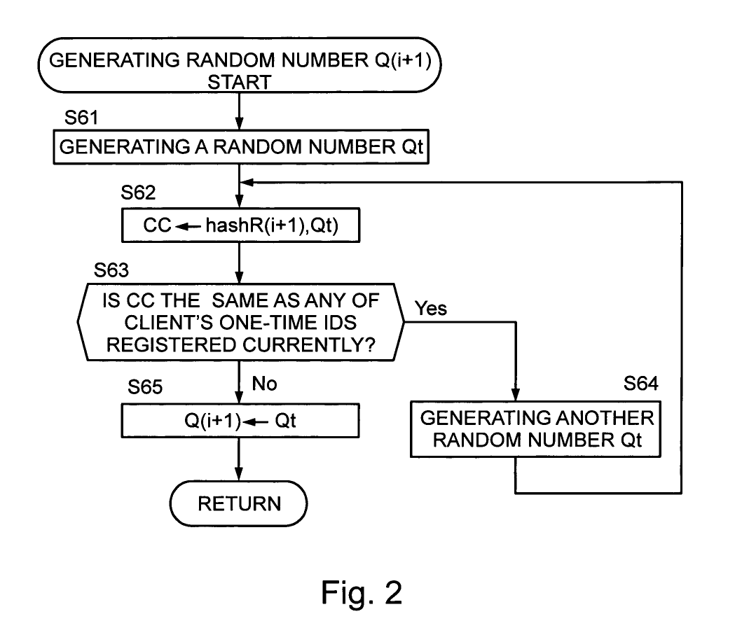

A flow chart for carrying out the generation of the server random numbers and verifying the uniqueness of client IDs using it, according to some embodiments of the invention, is shown in FIG. 2.

At S61 a candidate random number Qt is generated. At S62, a candidate client ID, CC, is generated. This candidate client random number is used to generate a candidate client one-time ID which is compared to client IDs that are currently registered at S63. If there is a match another random number is generated at S64 and its goodness is checked at S62 and S63. If the CC is unique, then the candidate Qt becomes Q(i+1) and is used in subsequent transmissions and processing.

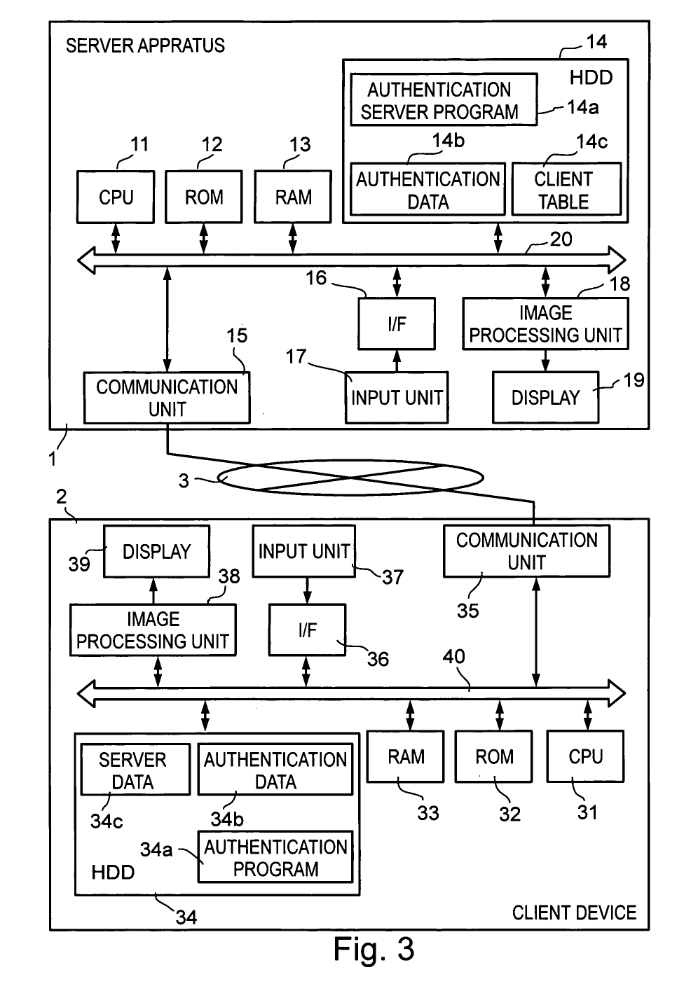

An exemplary apparatus for carrying out the method described with respect to FIGS. 1 and 2 is shown in FIG. 3.

A client device 2 includes a computer comprising CPU 31, RAM 33 and ROM 32 as well as a memory 34 containing an authentication program 34a, authentication data 34b and server data 34c. Generally speaking, the server data includes the current server random number value and the authentication data includes the current client random number R and the current (and optionally previous) K value. Memory 34 may store the current C and S or these (except for the initial value of K, Ko) can be generated on the fly as needed from the current and previous R and Q values. The memory also stores the program for authenticating the server and generating the IDs, etc. While memory 34 is shown as being differentiated, it can be a common memory for all of the data. Some of the data and programs can be stored on RAM 33 or ROM 32.

Elements 31, 32, 33 and 34 sit on a bus 40 to enable communication between them an optional display 39 (via an optional image processing unit 38) and an optional input unit 37, via an I/F 36. Many systems can operate without either a display or input unit and can simply be plug and play. In some embodiments input unit is used to input data to be sent to the server. Optionally, this information is sent to the server between authentications, optionally encrypted utilizing the current encryption key K.

Utilizing this methodology, not only is the authentication carried out periodically, but the crypto-key is also changed in conjunction with the authentication. Alternatively a different encryption key can be used for data and it can be sent to the server together with the current client random number R (both preferably encrypted using the current K).

The client device also includes preferably includes a communication unit 35 which connects the bus with a transmission medium 3. In some embodiment of the invention, transmission medium 3 is an internet. In some embodiments it may include means for connecting to the internet such as a wired or cable connection such as a telephone or other wired or cable connection or it can be a wireless connection. Other possible transmission media include wireless communication.

In some embodiments, the client is used to authenticate the use of a computer. In this case, the communications unit 35 would be a USB interface.

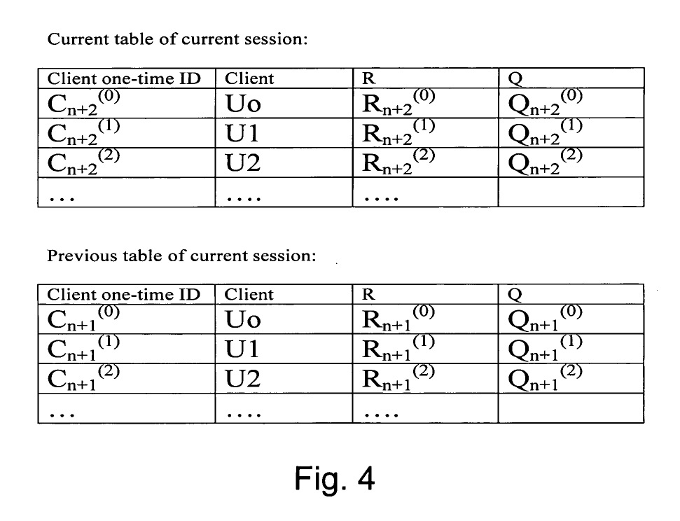

A server 1, has a similar construction to client 2 except that its memory 14 includes a client table 14c instead of the server data 34c of memory 34. Client table 14c includes current ID of all the clients and current Ks associated with all the clients. In order to speed up identification and changes in the values, the client table is preferably in RAM which may be volatile. The server, can thus determine if the C which it receives corresponds to a valid client and identify the client. As described below with respect to the recovery process, a table containing the same information with respect to the previous authentication session is also optionally saved. A sample table is shown in FIG. 4. This table is described below.

It is understood that the both the client and the server have software and/or hardware that can update the common key, encrypt the random number to be sent to the other of the server and client and to generate one time ID and random number.

To avoid any misunderstanding it is noted that in FIG. 4 all of the clients have the same index of random numbers. This is presented for simplicity. However, in practice, the index of each client will be different, depending on the number of authentications performed.

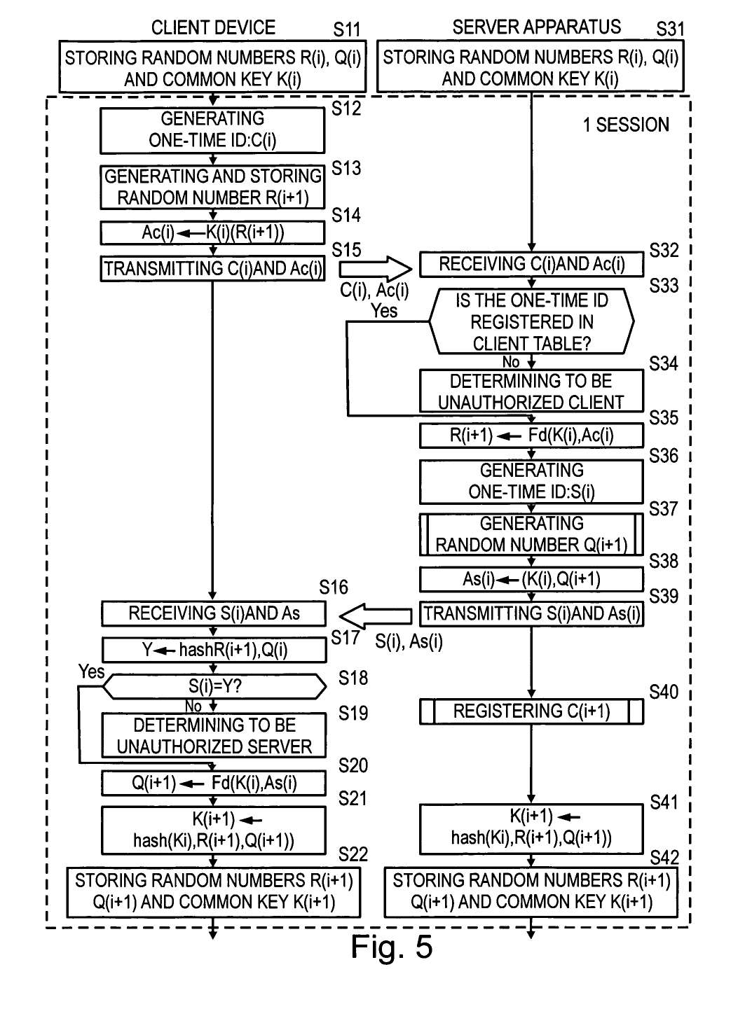

FIG. 5 shows the methodology of the embodiment of the invention shown in FIG. 1 in the form of a flow chart, with a starting point of R(i), Q(i) and K(i) at S11 and S31. The client first generates a one time ID at S12 and generates and stores a new random number R(i+1) at S13. The new random number R(i+1) is encrypted in accordance with a predetermined encryption function using K(i) as the encryption key to give a value of Ac at S15. K(i)(R(i+1)) is used to designate this encryption in both FIGS. 1 and 4. C(i) and Ac(i) are transmitted to the server at S32.

The server checks if the one time ID C(i) is registered on the client table at S33. If it is the server decrypts Ac(i) to produce R(i+1) using a predetermined decryption function Fd and the known K(i) at S35.

The server generates its one time ID, as the hash of (Q(i), R(i+1)) at S36. The server also generates a new server random number Q(i+1) at S37, which it encrypts using K(i) as an encryption key with function Fc to generate As (i) at S38. In some embodiments of the invention the encryption function is different for the server and the client. In some embodiments the same encryption function is used by both server and client. In some embodiments the same function is used for both authentication and data, in other embodiments, different functions are used. Thus, between one and four encryption functions can be used, depending on the embodiment.

The server also generates a new C(i+1) and stores it.

The server sends (at S39) S(i) and As(i) to the client which receives the data (at S16) and compares it (at S18) with hash of R(i+1), Q(i) which should be the same as that generated by the server at S36. Note that the hash may be generated at the client either on the fly (as shown at S17) or as soon as R(i+1) is generated at S13.

If the server is determined to be unauthorized (i.e., the internally generated hash does not match S(i)) then the communication is rejected at S19. If the S(i) is authenticated then Q(i+1) is decrypted using decryption function Fd and key K(i) on As(i). A new K(i+1) is generated at both the client (S21) and server (S41). The new R(i+1), Q(i+1) and K(i+1) are stored for use in the next cycle S22 and S42.

It is to be noted that after the initial exchange, there is no use of any initially stored information in subsequent authentications. Furthermore, it would appear to be extremely difficult to work backward or forward from any single or even two directional transmission that might be intercepted. This provides the system with an inherent robustness against hacking or a third party taking over the transmission. In general, when the transmission session ends, the initial values used to reestablish the transmission are the last values used (or rather the last values generated) as a result of the last authentication exchange before the transmission ends.

However, this also may make it difficult to restart communication when the transmission does not end cleanly, since the continuous update will then be broken and one or both parties will not be able to authenticate and/or identify the other.

Several kinds of communication breakdown are possible. Two which are most common are when the client fails to receive an authentication message from the server (referred to herein as a “communication error”) and where the server fails and all of its tables are lost which requires a reset. Other failure mechanisms include a breakdown at the client. However, it is expected that the client will store the temporary information such as Ri and Qi in its non-volatile memory and the client can restart with the stored information as if it had not had a breakdown. On the other hand, the server usually stores the temporary information in its volatile memory since it has to handle information of a large number of clients simultaneously and generally operates under time constraints that require it to retrieve the data quickly.

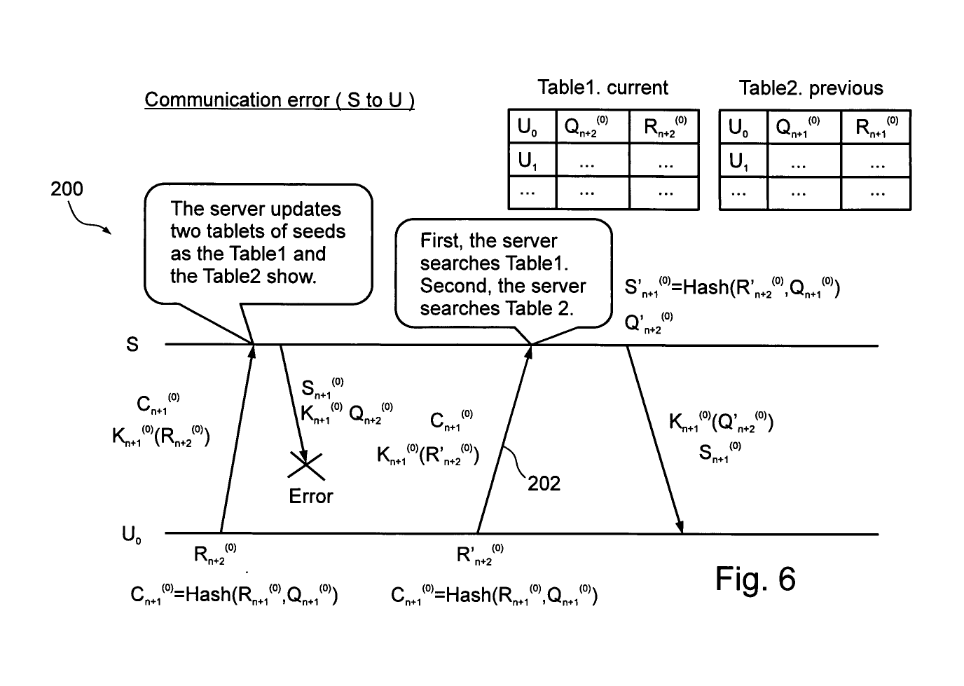

A methodology 200 for recovery from a communications error is described with the aid of FIG. 6. As shown, a user (designated as user “Uo”) has sent a user ID, Cₙ₊₁⁽⁰⁾ and a user random number Rₙ₊₂⁽⁰⁾, encrypted using an encryption key Kₙ₊₁⁽⁰⁾. In this representation, the previous authentication cycle is the (n+1)^{th} cycle and the present cycle is the (n+2)^{th} cycle. The superscript (0) represents the client number in the tables of FIG. 4. Since the server has received the authentication message from the client the current table has been updated with the new R, namely Rₙ₊₂⁽⁰⁾ and Q, namely Qₙ₊₂⁽⁰⁾. These values were used to generate the S value sent in the message that was not received. In the “previous” table stored in the server, the previous values for R and Q, namely Rₙ₊₁⁽⁰⁾ and Q, namely Qₙ₊₁⁽⁰⁾ are stored and a new expected ID Cₙ₊₂⁽⁰⁾ has replaced Cₙ₊₁⁽⁰⁾. It is assumed that all of the numbers have been updated between the two tables of FIG. 4. However, in practice, some of the numbers will not have been updated so that despite the difference in index values, the numbers for these clients will be the same in both tables.

When the client does not receive a reply, a second authentication request is sent. To reduce the possibility of hacking a new client random number R′ₙ₊₂⁽⁰⁾ is used as shown in the transmission indicated at 202. The server first searches the current client table. The one time ID Cₙ₊₁⁽⁰⁾ is not present in this table, since it has been replaced by a new ID Cₙ₊₂⁽⁰⁾. When the server sees that the ID received is not on the current table, the server checks the previous table. The server finds the previous ID Cₙ₊₁⁽⁰⁾ in that table and authenticates the client. The newly received R′ₙ₊₂⁽⁰⁾ is decrypted and a new Q, Q′ₙ₊₂⁽⁰⁾ is generated and used for the server transmission. This reestablishes the authentication cycle.

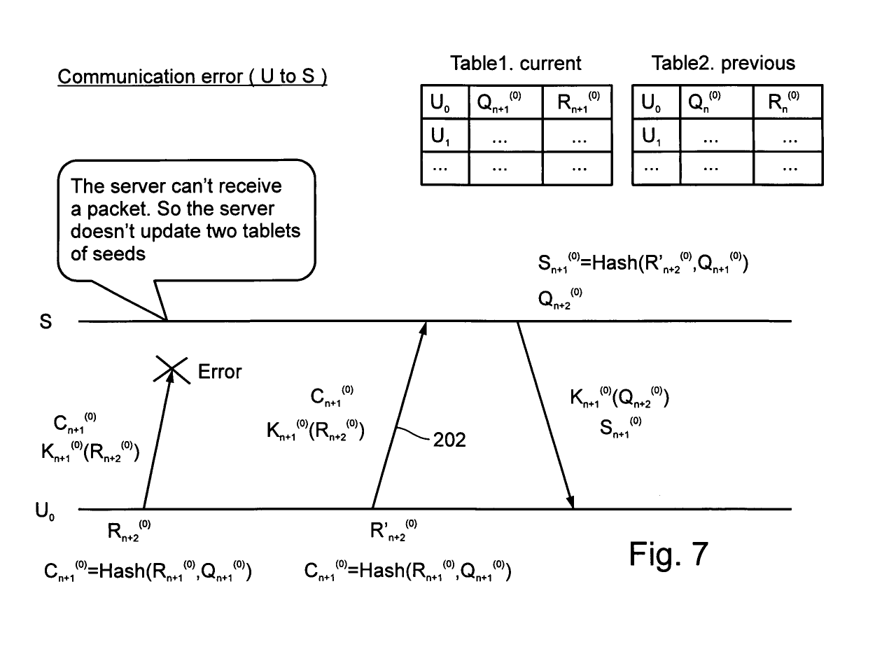

Another cause for the client not receiving an authentication message from the server is that the server did not receive the client's previous transmission. The methodology of recovery from this situation is shown in FIG. 7.

As in the situation described with respect to FIG. 6, the client does not receive a response from the server. As with respect to FIG. 6, the client generates a new random number and sends it in encrypted form to the server together with its current one-time ID (at 202). The server, on receipt of the message checks the current table and finds the current ID Cₙ₊₁⁽⁰⁾. It then continues as though there had been no loss of communication.

In an embodiment of the invention, the client requires an additional authentication cycle to assure itself that the server is genuine. In some embodiments of the invention, requiring lower security the client accepts the server as authentic based on the recovery procedures described above. This is provided to avoid the remote possibility that a third party will be able to capture the communication when two same client IDs are sent. Optionally, in such cases, a “re-authentication” flag may sent by the client to warn the server. Otherwise a “normal” flag is sent.

When the server fails, this usually results in a loss of all current tables in the server. In order to allow for reset and construction of a new table, the following exemplary procedure can be followed.

Each client is provided with an emergency procedure for reestablishing communication and a number of secret numbers to be used in such reestablishment (reset). Two common secret values are X and Qo. In addition, each client preferably has two secret numbers Z⁽⁰⁾ and Ro⁽⁰⁾. It should be understood that if the reset data is lost, then reset according to the following procedure can not be performed. Preferably, the reset data is stored on the HDD of the server and also in a different media, such as a CD-ROM, flash memory or other non-volatile memory that does not crash together with the HDD drive.

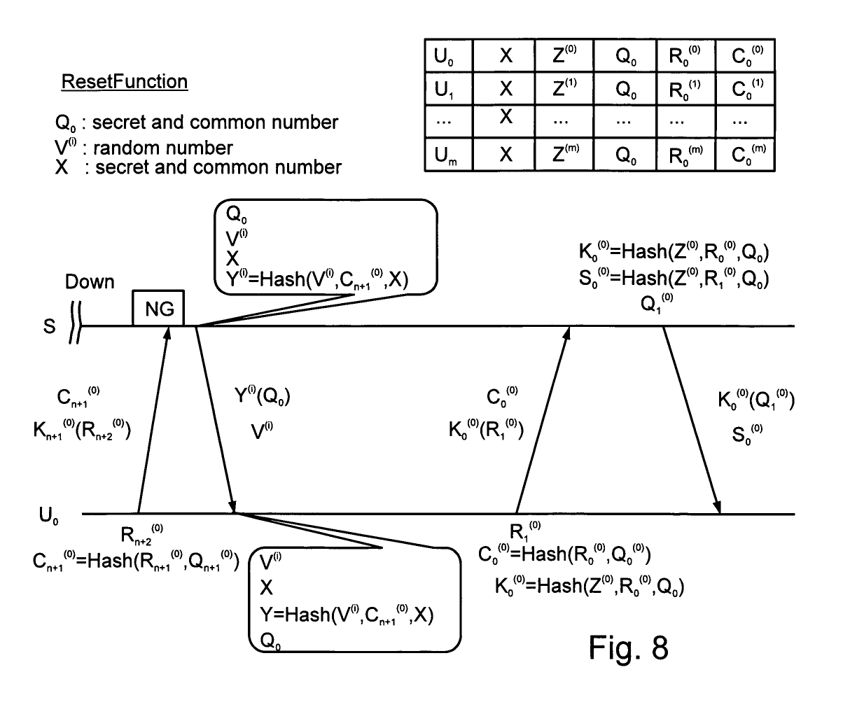

When reset is required, the client, who generally does not know of the need for a reset, sends an authentication request, utilizing an ID Cₙ₊₁⁽⁰⁾. The server, having lost the data needed to generate the current user ID can not recognize the ID as being genuine. The server also can not determine which client is sending the request. In this case the server sends a special response to indicate the problem. This response consists of a random number V⁽ⁱ⁾ and the hash of V⁽ⁱ⁾, Cₙ₊₁⁽⁰⁾, X, which is designated on FIG. 8 as Y⁽ⁱ⁾. V⁽ⁱ⁾, is sent in the clear or preferably is sent encrypted using a stored secret emergency encryption key.

The client, which knows the C that it sent and X, which is stored utilizes V⁽ⁱ⁾ to authenticate that the server is genuine. In other words the client generates Y⁽ⁱ⁾ and if this is the same as the Y(i) sent by the server, the identity of the server is authenticated. Alternatively, if a somewhat lower level of security is allowable, no random number V⁽ⁱ⁾ is used.

The client then generates a client random number R₁⁽⁰⁾ and generates a one-time ID as Co⁽⁰⁾=Hash(Ro⁽⁰⁾, Qo). Since Co⁽⁰⁾ identifies the user, this ID serves to identify the user. In addition the client generates an initial encryption key Ko⁽⁰⁾ as Hash (Z⁽⁰⁾, Ro⁽⁰⁾, Qo) and sends R₁⁽⁰⁾ in encrypted form using Ko⁽⁰⁾ as the encryption key. The use of Z⁽⁰⁾ is not absolutely required, but adds greater security to the system. If Z⁽⁰⁾ is not present then Co⁽⁰⁾ and Ko⁽⁰⁾ are the same which is not desirable since this makes it easier to hack in. Therefore, it is desirable to utilize a number Z⁽⁰⁾ in computing the encryption key.

At this point the server generates a server random number Q₁⁽⁰⁾, which it send to the client in the usual manner (as in FIG. 1). Since both the sever and the client now know a common R and Q, the system is recovered and periodic authentication as described above with respect to FIG. 1 can now proceed.

Preferably, a different V(i) is used for each client that attempts to reestablish communication.

While the invention has been described with random numbers being generated by both server and client for each authentication cycle, in some embodiments of the invention the random numbers are generated only on some cycles. On cycles in which the random number is not generated the existing random numbers are used. If at least one of the random numbers is generated each cycle then the security can be improved over the methodology in the previous section. However, in both cases security is lower than for the methods described above.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. For example, while the disclosure describes the client as the initiator of the authentication process, the server can also initiate the authentication process. Optionally, the authentication process is initiated by a trigger from the server or from a third party. Furthermore, the authentication process of the invention can also be used for peer to peer communications and for communications in which there is only a single computer and a single user. As used herein, where the term server is used, a peer user to the “client” is also meant.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method of mutual authentication between a server and a plurality of clients, comprising:
(a) generating, by a client, a first client random number and a first client one time ID based on first and second values;
(b) sending the first client one time ID and an encrypted version of the first client random number to the server by the client;
(c) generating, by the server, a first server random number and a first server ID based on the first client random number and the first value;
(d) sending, by the server, the first server one time ID and an encrypted version of the first server random number to the client by the server;
(e) generating, by the client, a second client random number and a second client one time ID based on said first server and first client random numbers;
(f) sending, by the client, the second client one time ID and an encrypted version of the second client random number to the server by the client;
(g) generating, by the server, a second server random number and a second server one time ID based on the second client random number and first server random number; and
(h) repeating (d) to (g), using updated random numbers and client and server one time IDs to provide periodic authentication, wherein the one time IDs thus generated do not contain any unchanging arguments intrinsically related to the two parties.

2. A method according to claim 1, wherein first and second numbers are numbers that are pre-stored in the client and server and are used, prior to (a), to initiate a first authentication cycle in place of the client and server random numbers.

3. A method according to claim 1, wherein the first and second numbers are random numbers that are generated in accordance with a previous authentication cycle.

4. A method according to claim 1, wherein the method is initiated by a trigger from outside the client and outside the server.

5. A method according to claim 1, wherein the method is initiated by a trigger from the server.

6. A method according to claim 1, wherein the method is initiated by the client.

7. A method according to claim 1, wherein the one time ID is an output of a one way function.

8. A method according to claim 7, wherein the one way function is a hash function.

9. A method according to claim 1, wherein the encryption utilizes a cipher-key that changes periodically.

10. A method according to claim 9, wherein the encryption utilizes an encryption key that changes with each authentication cycle.

11. A method according to claim 1, wherein the encryption key is responsive to first and second random numbers generated in a previous authentication cycle.

12. A method according to claim I and including identifying the client from the client ID and authenticating, by the server, that the client is authentic.

13. A method according to claim 1, wherein identifying and authenticating the client comprises:
determining by the server if the ID received from the client is an updated ID expected from one of the clients;
if it is not, checking if a next previous ID is an ID expected from one of the clients;
identifying and authenticating the client as a particular client if the received ID matches an expected ID from that client.

14. A method according to claim 13 and including authenticating the server by the client.

15. A method according to claim 14, wherein authenticating the server by the client comprises:
determining by the client if the ID received from the server is an updated ID expected from the server;
authenticating the client if the received ID matches an expected ID from the server.

16. A method according to claim 15:
wherein if the ID received from the server does not match an expected ID:
sending an authentication message from a client to a server, the message comprising the last valid one time ID sent by the client to the server;
determining by the server if the ID is an updated ID expected from one of the clients;
if it is not, checking if a next previous ID is an ID expected from one of the clients;
if it is, identifying the message as being from the client associated with the next previous ID and authenticating the client transmission; and
generating and sending according to a message to the server according to (c) and (d).

17. A method according to claim 1 and including sending data when the recipient of the data has been authenticated.

18. A method according to claim 17, wherein the data is sent in encrypted form.

19. A method according to claim 18, wherein the encryption used to send the data utilizes a same encryption key as used to encrypt the last random number sent by the sender.

20. A method according to claim 19, wherein the encryption used to send the data is sent using the same encryption function used to encrypt the last random number sent by the sender.

21. A method according to claim 1, wherein generating said server random numbers comprises:
(i) generating a candidate random number by the server;
(j) computing a candidate client one time ID based on the candidate random number;
(k) checking if the candidate client one-time ID is active for another client; and
(1′) if it is not, sending the candidate random number to the client;
(1″) if it is, repeating (i) to (k) until a candidate ID not in use is found.

22. A method according to claim 1, wherein the on-time IDs are, after an initialization period, based only on random numbers generated by the client and the server.

23. A method of generating one-time IDs in a system having a plurality of clients communicating with a server, in which the IDs for the clients are generated from random numbers supplied to the clients, comprising:
(a) generating a candidate random number by the server;
(b) computing a candidate client one time ID based on the candidate random number;
(c) checking if the candidate client one-time ID is active for another client; and
(d′) if it is not, sending the candidate random number to the client;
(d″) if it is, repeating (a) to (c) until a candidate ID not in use is found.

24. A method of recovery from a communication failure in a transmission system having a server and at least one client, in which the server and the client update their one-time IDs based on information received from each other, comprising:
sending an authentication message from a client to a server, the message comprising a one-time ID; and
determining by the server if the ID is an updated ID expected from one of the clients;
if it is not, checking if a next previous ID is an ID expected from one of the clients;
if it is, identifying the message as being from the client associated with the next previous ID and authenticating the client transmission.

25. A method according to claim 24, wherein the communication failure is a failure of the server receiving a message from the client.

26. A method according to claim 24, wherein the communication failure is a failure of the client receiving a message from the server.

27. A method according to claim 25, wherein the communication failure is a receipt by the client of a spurious message which appears to be from the server.

28. A method according to claim 1, wherein there is a loss of data that makes it impossible to identify the client from a one time ID generated by the client, the method comprising:
sending an authentication message by the client to the server, the message comprising a client one-time ID;
sending a response message by the server to the client comprising a server response based on the client one time ID and at least one confidential number common to all the clients;
determining, by the client, from the response message that the server is attempting to recover from a data loss; and
sending, by the client to the server, a recovery client ID, based at least on a confidential number specific to the server, such that on receipt, the server can identify the client.

29. A method according to claim 28, wherein the authentication message is based on the last valid client and server random numbers known to the client.

30. A method according to claim 28, wherein the authentication message and an accompanying client random number is the same as would have been sent by the client as in the absence of the failure in data, according to (a) and (b).

31. A method according to claim 30, wherein the server can not identify the client from the authentication message.

32. A method according to claim 28, wherein the response message sent by the server further comprises a random number.

33. A method according to claim 28, wherein the random number is sent unencrypted.

34. A method according to claim 33, wherein the at least one common confidential number is encrypted using an encryption key responsive to the client ID received by the server, a common secret number and the random number received from the server.

35. A method according to claim 28, wherein the at least one common confidential number is encrypted using an encryption key responsive to the client ID received by the server a secret number common to all the clients.

36. A method according to claim 28, wherein the client determines from the form of the response message that the server is attempting to recover.

37. A method according to claim 36, wherein the recover client ID is also based on a second, server, number that is common to all the clients.

38. A method of recovery from a loss of data in a server in a system in which one-time IDs are generated based on random numbers generated by both the server and the client, such that the loss of data makes it impossible to identify the client from a one time ID generated by the client, the method comprising:
sending an authentication message by the client to the server, the message comprising a client one-time ID;
sending a response message by the server to the client comprising a server response based on the client one time ID and at least one confidential number common to all the clients;
determining, by the client, from the response message that the server is attempting to recover from a data loss; and
sending, by the client to the server, a recovery client ID, based at least on a confidential number specific to the server, such that on receipt, the server can identify the client.

39. A method of mutual authentication between a server and a plurality of clients, comprising:
(a) generating, by a client, a first client random number and a first client one time ID based on first and second values;
(b) sending the first client one time ID and an encrypted version of the first client random number to the server by the client;
(c) generating, by the server, a first server random number and a first server ID based on the first client random number and the first value;
(d) sending, by the server, the first server one time ID and an encrypted version of the first server random number to the client by the server;
(e) generating, by the client, a second client random number and a second client one time ID based on said first server and first client random numbers;
(f) sending, by the client, the second client one time ID and an encrypted version of the second client random number to the server by the client;
(g) generating, by the server, a second server random number and a second server one time ID based on the second client random number and first server random number; and
(h) repeating (d) to (g), using updated random numbers and client and server one time IDs to provide periodic authentication, wherein the on-time IDs are based on a function having, after an initialization period, as arguments only random numbers generated by the client and the server.

40. A method of mutual authentication between a server and a plurality of clients, comprising:
(a) generating, by a client, a first client random number and a first client one time ID based on first and second values;
(b) sending the first client one time ID and an encrypted version of the first client random number to the server by the client;
(c) generating, by the server, a first server random number and a first server ID based on the first client random number and the first value;
(d) sending, by the server, the first server one time ID and an encrypted version of the first server random number to the client by the server;
(e) optionally generating, by the client, a second client random number and a second client one time ID based on said first server and first client random numbers;
(f) sending, by the client, the second client one time ID and an encrypted version of the second client random number to the server by the client;
(g) optionally generating, by the server, a second server random number and a second server one time ID based on the second client random number and first server random number; and
(h) repeating (d) to (g), using updated random numbers and client and server one time IDs to provide periodic authentication, wherein the one time IDs thus generated do not contain any unchanging arguments intrinsically related to the two parties,
wherein at least one number generated according to (e) or (g) is used on each authentication cycle and wherein where no new random number is used the subsequent sending utilizes the next previous generated random number.
